(19) United States
(12) Patent Application Publication
(10) Pub. No.: US 2010/0236244 A1
(43) Pub. Date: Sep. 23, 2010

(54) Heat absorbing and reflecting shield for air breathing heat engine

(76) Inventor: Robert L. Longardner, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 11/476,290

(22) Filed: Jun. 28, 2006

(51) Int. Cl. F02B 73/00

(52) U.S. Cl. 60/698

(57) ABSTRACT

A system for adjusting ambient air temperature shielding an engine. The system includes an engine having first and second ends and a heat generating source, and a shield having a substantially cylindrical portion defining an interior cavity. At least a portion of the heat generating source is disposed in the cavity. The shield has a heat reflecting interior surface facing the cavity and an opposing exterior surface. The interior surface reflects heat generated by the heat source.

### BACKGROUND OF THE INVENTION

1. Field of the Invention

The present invention pertains to air breathing heat engines such as combustion turbines (CT) comprised of a compressor, combustor, and turbine, and, in particular, to a system for cooling such heat engines.

2. Description of Related Art

The aero-derivative and framed CTs are rapidly becoming the power generators of choice for electrical power and for direct drive. Earlier applications of CTs were configured to meet spikes in energy dispatch and to meet those spikes with very little regard for heat rates. Due to many favorable features of CTs such as being relatively environmental friendly, as well as improvement in heat rates and reduced capital costs, CTs are increasingly being employed in intermediate and base load generation and now likely will be the wave of the foreseeable future.

It is obvious that when the compressor aspects of a CT are cooled, the work compressing the air mass is reduced. For the same reason, aero derivative CTs have greater power output when the aircraft say flying at 25,000 feet as days when the aircraft when flying at 5,000 feet. Likewise, when the dry bulb temperature falls the thermal efficiency of the turbine is improved.

In stationary power generation mode, the current acoustical housing and/or enclosures are designed to absorb sound energy achieving free-field noise emission levels not exceeding 63 decibels at 200 feet and to provide for weather protection. These enclosures are structured around the power take-offs, the hot section of the turbine, the combustors, and the compressors. The engines aspects within the enclosure convect, conduct, and radiate at the rate of the thermal loss expressed as the over-all transformation efficiencies which can be calculated:

$$\frac{\frac{Turbine Heat Btus {/}^{\#}}{sec} - \frac{Compressor Heat Btus {/}^{\#}}{sec}}{\frac{Combustor Heat Btus {/}^{\#}}{sec}}$$

Energy Transformation in the Compressor Aspects: The rotating blades (or impellers) adiabatically transfer heat energy to the flow of the air (gas) as per the pressure ratio and the physical characteristics of the compressor. This mechanical work causes a temperature rise in the flow of air. Also when the radiation from the combustor aspects is reflected into the compressor aspects, it causes an additional temperature rise, all of which reduces the efficiencies of the compression of air (gas).

Energy Transformation in the Combustor Aspects: The energy stored in the flow of air (gas) is increased by raising its temperature. This is a conversion of chemical energy to an enthalpy rise based upon the heating value of the fuel. The combustor aspects (basket metal temperature) along the axis will attain heat at temperatures that radiate off to the surrounds. This radiation of heat energy also is reflected into the compressor and turbine aspects affecting the thermal efficiencies of the CT.

Energy Transformation in the Turbine Aspects: When the high pressure/high temperature air (gas) expands through the turbine, its energy is transferred from the air to the rotating blades. This combustion gas diffused and expanded into the turbine at a rate depending temperature drop, and when the radiated heat from the combustor is reflected into the turbine aspects, this reheat from combustor radiation hinders the drop in temperature along with slowing down the rate of gas expansion which essentially reduces the power thereby reducing the thermal efficiencies.

Typical stationary mode CT thermal efficiency is affected when heat is radiated from the combustor back into the compressor and turbine aspects. This bounced, reflected, radiated heat from the combustor causes the compressor aspects to gain heat which causes a temperature rise beyond that which would have been attained simply from the heat of compression. This radiated heat, as an example, will cause a loss of thermal efficiency on a 90° F. day on average of a calculated 5%⁺, likewise the radiated heat reflected into the turbine could result in a loss in efficiency calculated at 4%⁺.

The U.S. Pat. No. 6,082,094 entitled “Ventilation System for Acoustic Enclosures for Combustion Turbines and Air Breathing Heat Engines” teaches a method of cooling and ventilating in the acoustical box enclosure. While the radiated heat from the combustor can be shielded and reflected back into the combustor (at about 50,000 Btu/sq ft/hr) reduces the fuel burn slightly with a corresponding reduction in heat rate. A problem with the heat produced and convected in existing acoustic enclosures is the tendency to retain that heat being produced by the CT components. In particular, all things being equal, CTs shielded by high temperature air operate less efficiently than turbines shielded by cooler air. Although some of the heat produced in energy transformation by the CT is removed by oil cooling systems and engine exhausts, an appreciable amount of heat is transferred to the enclosure and the air contained therein. This transferred heat causes the air in the enclosure to increase in temperature, which tends to adversely affect CT efficiency.

To offset the radiated, converted, and conducted energy from the operation of a CT confined to an acoustical enclosure and power take-off entrapments within the enclosure, the ambient is filtered air at a rate between 10-20 cfm per kilowatt and vented to the CT forcibly by blowers through the enclosure as a coolant. However, the cooling capabilities of such a configuration is less than desired and heat continues to be a problem with regard to the CTs with subsequent reduction in thermal efficiencies.

In response to problems resulting from radiated and convected energy from operating the CT, the inventor of the present invention proposed an enclosure for the CT into which air, conditioned and cooled, was directed to cool the compressor portion of the CT. This proposition is disclosed in U.S. Pat. No. 6,082,094, issued to the inventor of the present invention on Jul. 4, 2000, and expressly incorporated herein by reference. However, such enclosures require a mechanism for removal of this heating from within the enclosure, which may increase the number of components and the cost of the system.

CTs also experience overheating from the radiated and convected energy even if no enclosure is provided. An acoustical enclosure of the annular combustor aspects of the CT is such that it radiants heat energy emitted from the combustor in all radial directions. With such radial emission of heat, the compressor aspect of the CT absorbs heat that is reflected from the combustor, thereby creating a situation where the compressor aspects may become overheated by the radiated heat energy which negatively affects the CTs overall thermal efficiency.

### SUMMARY OF THE INVENTION

The present invention provides for the means to absorb the radiated and convected heat from compression aspects into a ducted stream of conditioned air. Further, the invention provides for the means to reflect the heat energy waves into the combustor aspects and shielding heat energy from the compressor and turbine aspects, all of which provides the means to enhance the overall thermal efficiencies of the CT.

The present invention further provides a power generation system including an air breathing heat engine CT including an intake for delivery of air to the CT and an outlet for exhaustion of compression and combustion gases from the acoustical enclosure. The air breathing heat engine includes a heat generating source and a ducted shield defining an interior cavity in which the conditioned ambient air as a chillate absorbs the radiated heat energy and convects them into the ventilation of the enclosure.

The present invention further provides the CT an air breathing heat engine with a reflector surrounding the combustor aspects that shield the compressor and turbine aspects from the reflected heat from the combustor. The curved reflective shield surrounding the combustor has at least one absorption surface with ducting for conditioned cooling by an air stream which will maintain a differential in the surface temperature between combustor and the absorptive reflective shield. The reflective shield is formed to reflect the radiated heat back into the combustor aspects while shielding the compressor and turbine aspects from the stray radiated heat. Reflecting the radiated heat back into the combustor aspects while shielding the compressor and turbine aspects provides for a more efficient use of fuel and thereby minimizing the overall heat rate.

The present invention provides a method of adjusting a temperature within a power generation system including operating a prime mover having a motion impeller to create motion, connecting an electrical generator to the prime mover, generating electrical energy at the electrical generator by utilizing the motion of the prime mover, and shielding the generator to minimize the temperature of the generator.

The invention further provides for the reflection of radiated heat from prime movers other than combustion turbines. The geometrics that shape the surround of prime movers (say electric motors) will conform so to reflect away from the prime mover the radiated heat energy. To direct the heat energy away from the reflective shield, means for keeping the shield cool may be implemented, such as a ducted, refrigerated cool air stream convecting the absorbed radiated heat away from the prime mover (motor).

### BRIEF DESCRIPTION OF THE DRAWINGS

The above mentioned and other advantages and objects of this invention, and the manner of attaining them, will become more apparent and the invention itself will be better understood by reference to the following description of an embodiment of the invention taken in conjunction with the accompanying drawing, wherein:

FIG. 1 is a schematic front view of a ventilating system for the housing of a combustion turbine;

FIG. 2 is a sectional view of an existing combustion turbine which is part of a ventilation system of FIG. 1;

FIG. 3 is a sectional view of the combustion turbine of FIG. 2 including a shield proximate the compressor portion in accordance with one embodiment of the present invention; and

FIG. 4 is a schematic view of a combustion turbine including a shield in accordance with another embodiment of the present invention.

Corresponding reference characters indicate corresponding parts throughout the several views. Although the drawings represent an embodiment of the present invention, the drawings are not necessarily to scale and certain features may be exaggerated in order to better illustrate and explain the present invention. The exemplification set out herein illustrates an embodiment of the invention and such exemplification is not to be construed as limiting the scope of the invention in any manner.

### DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended.

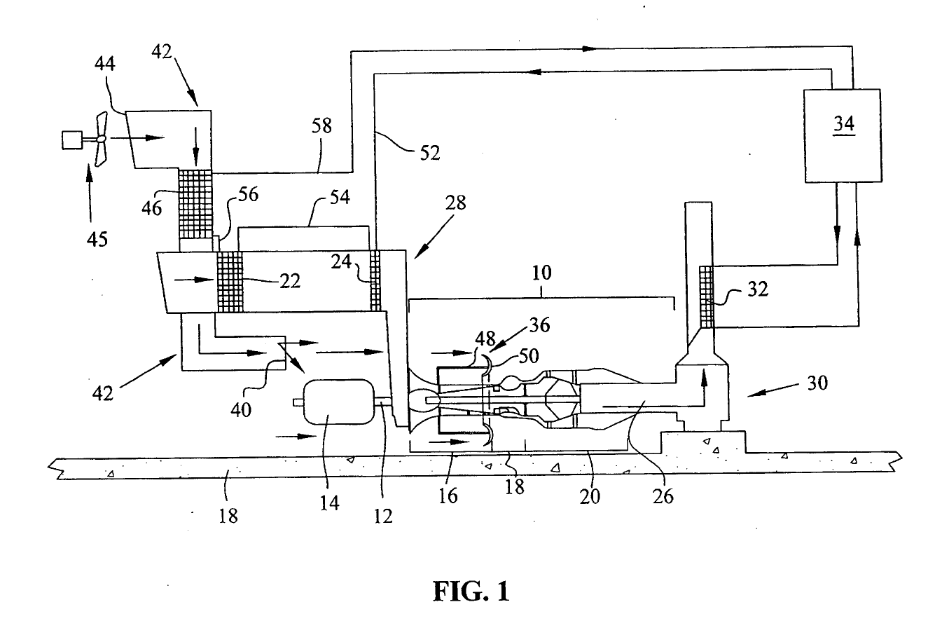

Referring now to FIG. 1, a combustion turbine, or air breathing heat engine, is schematically shown at 10, and as is conventional with such gas turbines, includes compressor 16, combustion portion 18, and turbine 20. Turbine 20 utilizes the gases from combustion portion 18 to drive shaft 12, which is drivingly connected to generator 14 for power generation. Turbine 10 operates in the stationary mode in that, unlike the aero-related turbines on which its design is based and which are naturally moved while used in flight, the turbine is fixedly mounted to a support surface or on the ground during use.

Intake air duct 28 supplies air to compressor 16 of turbine 10. Ambient air entering into duct 28 passes sequentially through vapor condensing heat exchanger 22 and cooling heat exchanger 24 to be conditioned prior to entering turbine compressor 16. The turbine exhaust is ported through conduit 26 to waste heat recovery unit and stack exhaust system 30 that exhausts to the atmosphere. Heat exchanger 32 positioned within a flue of the exhaust stack is used to draw heat off of the combustion gases being exhausted in order to power an absorption refrigeration unit, which is abstractly shown at 34, that supplies chillate to the heat exchangers 22 and 24.

Proximate shoe 36 is proximal inlet opening 40 which is in air flow communication with the downstream end of an intake air duct, or shaft, 42. Intake air duct 42 includes inlet end 44 that is open to the atmosphere and fans, or blowers, 45 are provided to force air into inlet end 44 and through the ventilation intake air duct 42. Blowers 45 alternatively may be provided at other points along the ventilation system, including such as within the ventilation exhaust duct, to force or draw air through the system. Air entering duct 42 through inlet end 44 passes through a filter (not shown) and through a vapor condensing heat exchanger generally shown at 46 mounted within the interior of intake duct 42. Although shown closer to inlet end 44 than shoe 36, heat exchanger 46 may be alternatively positioned along the length of intake duct 42, such as closer to or immediately adjacent inlet opening 40 within the scope of the present invention.

Vapor condensing heat exchanger 46 may be of conventional design including a cooling coil over which air flows and which provides a circuitous path for relatively low temperature chillate being carried therethrough. The cooling coil includes cooling coil tube sections that are arranged in rows and columns in air duct 42 and that are oriented to be generally transverse to the flow of ambient air being conveyed through duct 42. The cooling coil tube sections may be arranged, for example, to extend horizontally and with spacing between the cooling coil tube sections to provide a large surface area for contact with passing air. While single inlet and outlet chillate lines for heat exchanger 46 are shown, multiple inlet lines and outlet lines may be used and separately circuited to the coil tube sections within the scope of the present invention.

Vapor condensing heat exchanger 46 removes the heat from the airstream by firstly condensing the vapor (rejecting 970 BTU per pound of water) followed by a cooling of the remainder of the vapor air mixture. This conditioning of the air results in better cooling capabilities of the ventilation system.

By conditioning the air to a relatively low dry bulb and wet bulb temperature, the system is better cooled, and the efficiency of combustion turbine 10 is improved. By way of example to illustrate the benefits of cooler air, the specific heat in comparable air mixtures is, at sea level pressure, 20.16 BTU/ft³ when at 55° F. @ 80% Relative Humidity (R.H.) and 54.74 BTU/ft³ when at 95° F. @ 80% R.H. These numbers evidence that an air mixture of 55° F. @ 80% R.H. would have a calculated cooling advantage of 34.58 BTU/ft³ over the air mixture at 95° F. @ 80% R.H.

Vapor condensing heat exchanger 46 is preferably sized and arranged to condition the intake air flowing through air duct 42 such that air exiting heat exchanger 46 is cooled to between approximately 45° F. and 50° F., and preferably 45° F., and to one hundred percent relative humidity. Heat exchanger 46 may be configured to condition air to different air temperatures, including temperatures higher than these preferred values, provided such conditioned air temperatures are satisfactory to achieve suitable cooling of the system; the same configuration can be used to heat the system.

Vapor condensing heat exchanger 46 is shown in FIG. 1 being supplied with chillate that has already been circulated through heat exchangers 22 and 24 in air duct 20. In particular, the exchangers may be plumbed in series such that chillate, for example water at 42° F., is introduced to the inlet of heat exchanger 24 through thermally insulated conduit 52 from absorption refrigeration system 34, passes from heat exchanger 24 to heat exchanger 22 through thermally insulated conduit 54, passes from heat exchanger 22 to vapor condensing heat exchanger 46 through thermally insulated conduit 56, and is returned at a higher temperature from heat exchanger 46 to refrigeration system 90 through thermally insulated conduit 58. In order to ensure the chillate delivered to heat exchanger 46 is adequately cold to suitably cool the ventilating air, in an alternate embodiment, chillate at between 42-44° F. may be provided directly from the refrigeration system to heat exchanger 46. For example, heat exchangers 46, 22, and 24 may be plumbed in parallel.

The chillate may be provided by, and the conduits 52 and 58 may be connected to, an absorption refrigeration system of the type described in U.S. Pat. No. 4,936,109, the complete disclosure of which is incorporated fully herein by reference. This type of system, from an energy standpoint, is non-parasitic (that is, the refrigeration does not draw off the generated electricity). Other refrigeration processes which are known in the art may be used to provide chillate to the heat exchangers within the scope of the invention. For example, the chillate may be produced using a conventional vapor-compression refrigerator that may be, for example, powered by an external power source of conventional design so as to be an energy parasitic system.

Although not shown, the ventilation ducts, and in particular the air intake duct 42, may be equipped with a stop valve to selectively open and close off the ventilating system from the ambient air. For example, in cold weather, it is desirable to prevent an influx of cold air through duct 42 and, as a result, around shield 36 when the system is initially started.

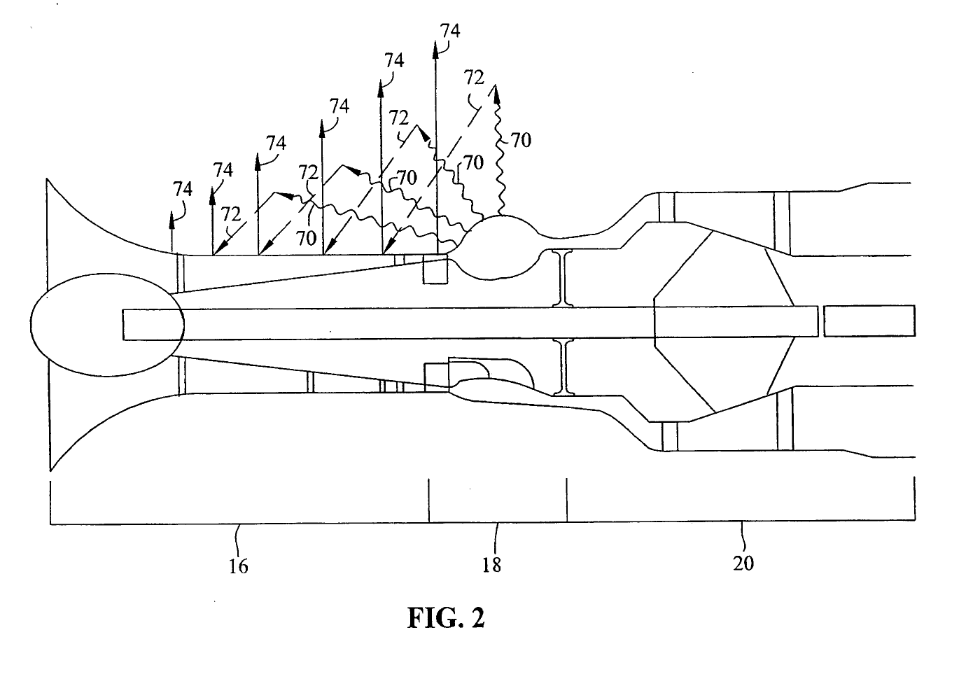

Heat absorbing shield 36 includes two main portions, cylindrical portion 48 and curved portion 50, to cool compressor 16 of combustion turbine 10. As shown in FIG. 2, radiant heat produced by combustion portion 18 is able to emanate from combustion portion 18 and to be absorbed to a certain extent by compressor 16, as indicated by arrows 70, 72, and 74. As such, compressor 16 may absorb heat and may experience a decreased efficiency and greater wear due to that inefficiency.

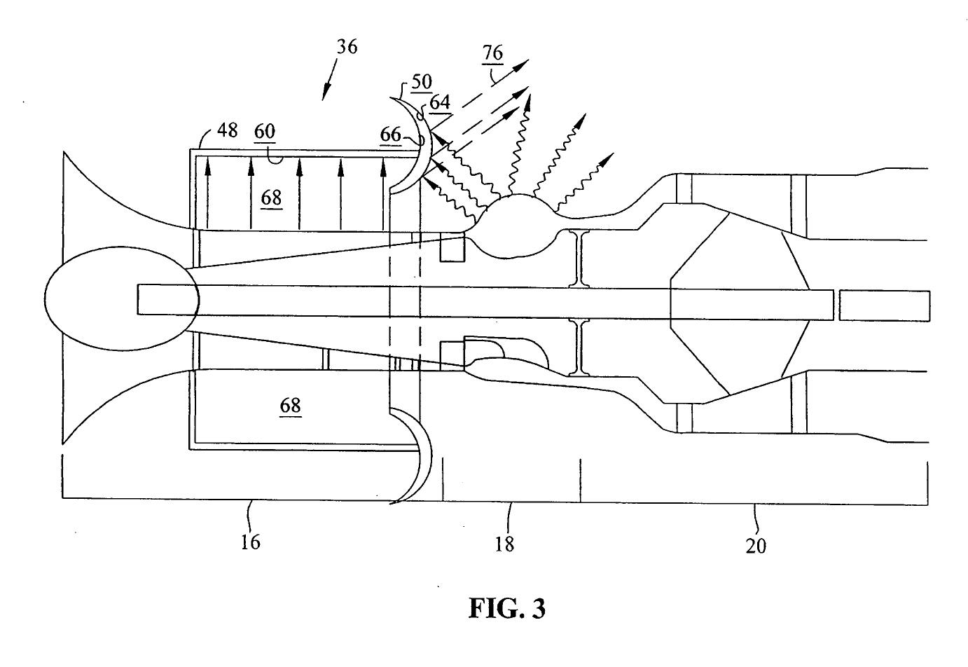

As shown in FIG. 3, shield 36 is placed over a portion of combustion turbine 10, specifically compressor 16, to absorb a portion of the excess heat and to reflect a portion of the excess heat coming from combustion portion 18. Cylindrical portion 48 is structured to define interior cavity 68 between compressor 16 and cylindrical portion 48. Cylindrical portion 48 has interior absorptive surface 60 which absorbs heat from compressor 16 as indicated by arrows 62, that heat being received by compressor 16 from combustion portion 18. By absorbing this heat, the heat is then not retained within compressor 16 to cause a reduction of efficiency, but is instead pulled away from compressor 16 to provide improved, or at least stable, efficiency. Shield 36 further includes curved portion 50 proximal combustion portion 18. Curved portion 50 includes reflective surface 64 and absorbing surface 66 on a side of curved portion 50 opposite reflective surface 64. As indicated by arrows 76, the radiant heat from combustion portion 18 radiates outwardly toward compressor 16 but instead of being absorbed by compressor 16, and surface 64 of curved portion 50 is structured and arranged to reflect the heat by back to combustion portion 18. However, curved portion 50 does not abut compressor 16, thus some radiant heat energy is capable of being absorbed by compressor 16. Specifically, the radiant heat energy is able to enter interior cavity 68 and be absorbed by surface 60, as indicated by arrow 62, or alternatively be absorbed by surface 66 of curved portion 50; however, in either case the radiant heat energy is pulled away from compressor 16.

To further enable cooling of compressor 16, air from inlet 44 and exiting at outlet 40, is allowed to blow over cylindrical portion 48. This air, which has been cooled to 42° F., cools cylindrical portion 48 so that heat which is absorbed by cylindrical portion 48 is then removed by natural heat exchange through cylindrical portion 48 being cooled to absorb further heat from compressor 16. The same can be said of curved portion 50 which also is cooled by the air passing over it. Thus, by use of a less complex cylindrical portion and curved shield structure, compressor 16 is able to be cooled relatively easily and efficiently.

Although shield 36 has been described as being used with combustion turbine 10, other such electrical generating devices utilizing heat energy may be used with shield 36. Whenever heat is generated for creation of electrical energy, heat may also be radiated therefrom and be absorbed by other related devices. Thus, the use of shield 36 would protect additional devices through its absorbing and reflecting of the radiant heat energy. Other such devices may include heat engines, other turbines, or other combustion related engines.

Although not shown, automatic controls for the ducts and the heat exchanger, with appropriate sensors, may be provided in the shown ventilating system to insure compressor 16 is properly ventilated with cooled air from heat exchanger 46. The inventive ventilating system, due to the improved cooling of compressor 16 by shield 36, reduces the severity of creep in the engine components and improves CT aspects and the turbine efficiency.

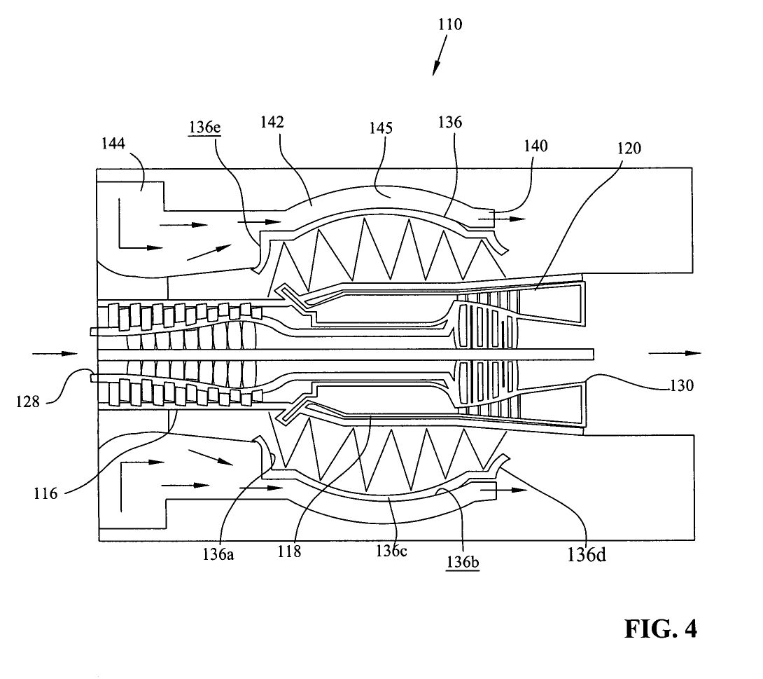

Referring now to FIG. 4, combustion turbine or air breathing heat engine 110 according to another embodiment of the present invention is schematically shown. Turbine 110 includes compressor 116, combustion portion 118 and turbine 120. Turbine 120 operates similar to turbine 10 in FIGS. 1-3. Intake air duct 128 supplies air to compressor 116 of turbine 110. The air entering into duct 28 may be pre-conditioned prior to entering compressor 116 by any means including, for example, the method described in U.S. Pat. No. 4,936,109 issued on Jun. 26, 1990 to R. Longardner, the inventor of the present application, and hereby incorporated by reference.

Heat absorbing shield 136 is positioned about combustion portion 118 and includes somewhat cylindrically-shaped barrel portion 136c, first lip portion 136a and second lip portion 136d. First and second lip portions 136a, 136d are disposed at opposite ends of barrel portion 136c and extend inwardly from barrel portion 136c. Shield 136 includes interior surface 136 b which is formed of a reflective material adapted reflect the heat emanating from combustion portion 118 back toward combustion portion 118 and away from compressor 116, thereby preventing compressor 116 from overheating. Shield 136 may be formed of any material capable of reflecting the heat back to combustion portion 118. For instance, shield 136 may be formed of a metal such as nickel, chrome, iron or alloys thereof such as Inconel. As illustrated in FIG. 4, barrel portion 136a bows outward to further aid in the reflection of heat toward combustion portion 118. First lip portion 136a of shield 136 further blocks the heat emanating from combustion portion 118 from reaching compressor 116. First lip portion 136a includes exterior surface 136e, which may be adapted to absorb heat from compressor 116, as described above with respect to shield 36 (FIGS. 1-3).

To further prevent the overheating of compressor 116, air duct 142 is provided. Air duct 142 extends along the outside of turbine 110 from compressor 116 to turbine 120. Air duct defines channel 145 and includes inlet 144 and outlet 140 in fluid communication with channel 145. Channel 145 may be partially defined by the exterior surface of shield 136 such that the air flowing through channel 145 contacts the exterior surface of shield 136. Alternatively, channel 145 may be partially defined by a wall (not illustrated) that abuts the exterior surface of shield 136. Cooled ambient air is directed into air duct 142 via inlet 144. The air entering inlet 144 may be pre-conditioned by any means including, for example, that disclosed in U.S. Pat. No. 6,082,094 issued on Jul. 4, 2000 to Robert Longardner et al., the inventor of the present invention and hereby incorporated by reference. This cooled air travels through duct 142 and exits duct 142 via outlet 140. As the cooled air travels through duct 142 it contacts the exterior surface of shield 136 and cools barrel portion 148.

While this invention has been described as having exemplary structures, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A system for adjusting ambient air temperature shielding an engine, the system comprising:
an engine having first and second ends and a heat generating source with a generator; and
a shield having a substantially cylindrical portion defining an interior cavity, at least a portion of said heat generating source being disposed in said cavity, said shield having a heat absorbtive interior surface facing said cavity and an opposing exterior surface having a heat reflecting exterior surface, said interior surface and said exterior surface configured and arranged to reflect dissipate heat generated by said heat source, said shield being made of one of the following materials: nickel, chrome, iron, and an alloy thereof.

2. The system of claim 1 wherein said engine includes a compressor disposed proximal said heat generating source and outside of said cavity, said shield includes a first lip portion extending radially inward from a first end of said cylindrical portion, said lip disposed proximal said compressor.

3. The system of claim 1 wherein said shield includes a second lip portion extending radially inward from a second end of said cylindrical portion.

4. The system of claim 2 wherein said first lip portion includes an absorptive outer surface.

5. The system of claim 1 further comprising:
a ventilating duct disposed proximal to and extending along said cylindrical portion of said shield, said ventilating duct including a duct channel, an inlet in communication with said duct channel and an outlet in communication with said duct channel, said ventilating duct receiving cooled air through said inlet and flowing said cooled air through said channel.

6. The system of claim 5 wherein said channel is at least partially defined by said exterior surface of said shield.

7. The system of claim 5 wherein said channel is at least partially defined by a channel wall, said channel wall in heat-exchanging contact with said exterior surface of said shield.

8. The system of claim 1 wherein said engine is an air breathing heat engine and said heat generating source is a combustor.

9. A power generation system comprising:
an air breathing heat engine including an intake device for delivery of air to said heat engine and an outlet device for exhaustion of combustion gases from said heat engine, said engine including a heat generating source and a generator; and
a shield defining an interior cavity in which at least a portion of the engine is disposed, said shield having an open inlet end and an open outlet end and at least one heat reflecting surface facing said heat generating source, said shield having a heat absorbtive interior surface facing said cavity and an opposing exterior surface having a heat reflecting exterior surface, said interior surface and said exterior surface configured and arranged to dissipate heat generated by said heat source, said shield being made of one of the following materials: nickel, chrome, iron, and an alloy thereof.

10. The power generation system of claim 9 wherein said shield includes a cylindrically shaped portion extending about said heat generating source.

11. The power generation system of claim 9 further comprising a curved portion substantially transverse to said heat reflecting surface, said curved portion adjacent said outlet end and having an absorptive surface.

12. The system of claim 9 wherein said engine includes a compressor disposed proximal said heat generating source and outside of said cavity, said shield includes a cylindrical portion and a first lip portion extending radially inward from said cylindrical portion at said inlet end, said lip disposed proximal said compressor.

13. The system of claim 12 wherein said shield includes a second lip portion extending radially inward from said cylindrical portion at said outlet end.

14. The system of claim 12 wherein said first lip portion includes an absorptive outer surface.

15. The system of claim 12 further comprising:
a ventilating duct disposed proximal to and extending along said cylindrical portion of said shield, said ventilating duct including a duct channel, a duct inlet in communication with said duct channel and a duct outlet in communication with said duct channel, said ventilating duct receiving cooled air through said duct inlet and flowing said cooled air through said channel.

16. The power generation system of claim 9 wherein said heat engine includes a compressor portion and a combustion portion.

17. An air breathing heat engine comprising:
a compressor portion;
a combustion portion adjacent said compressor portion, said combustion portion creating radiant heat energy;
a generator coupled to said combustion portion; and
a shield with a cylindrical portion defining an interior cavity in which at least a portion of said compressor portion is disposed, said shield having at least one absorptive surface and an open inlet end and an open outlet end, said shield including a curved portion at said outlet end, said curved portion being substantially transverse to said cylindrical portion and having an absorptive surface and a reflective surface, said shield having said heat absorbtive interior surface facing said cavity and said exterior surface having said heat reflecting surface, said interior surface and said exterior surface configured and arranged to dissipate heat generated by said heat source, said shield being made of one of the following materials: nickel, chrome, iron, and an alloy thereof.

18. The engine of claim 17 wherein said reflective surface is proximal to and faces said combustion portion.

19. The engine of claim 17 wherein said absorptive surface is proximal to and faces said compressor portion.

20. The engine of claim 17 further comprising a ventilating duct disposed proximal to and extending along said cylindrical portion of said shield.
